(19) United States
(12) Patent Application Publication
(10) Pub. No.: US 2004/0015637 A1
(43) Pub. Date: Jan. 22, 2004

(54) Multiple bus interface for a computer system

(76) Inventor: Cedric Yau, Portland, OR (US)

Correspondence Address: Chernoff Vilhauer McClung & Stenzel, L.L.P., 1600 ODS Tower, 601 SW Second Avenue, Portland, OR, 97204-3157, US

(21) Appl. No.: 10/200,881

(22) Filed: Jul. 22, 2002

(51) Int. Cl. G06F 13/20

(52) U.S. Cl. 710/313; 710/315

(57) ABSTRACT

A multiple bus, serial interface permits aggregation of a plurality of modular computer peripherals having differing interfaces into a computer system.

### CROSS-REFERENCE TO RELATED APPLICATIONS

Not applicable.

### BACKGROUND OF THE INVENTION

The present invention relates to an I/O (input-output) interface for a computer system and, more particularly, to an I/O interface accommodating interconnection of an aggregation of computer devices having differing communication interfaces.

Microprocessor-based computer systems are extremely versatile and are used in virtually every facet of human life. The versatility of microprocessor-based computer systems is, largely, the result of the modular nature of the hardware and software that are used in these systems. A particular system can be appropriately configured for a combination of generalized and specialized tasks by aggregating generic and specialized hardware and software into a complete system. The hardware of a microprocessor-based computer system comprises, generally, a central processing unit that is interconnected with modular memory and one or more attached devices or peripherals facilitating data input, output, and storage. Computer peripherals are available from a number of manufacturers, serve a wide variety of functions, utilize an array of operating mechanisms and software, and incorporate a wide range of optional features. The physical operation of a computer peripheral is typically controlled by specialized software, known as a device driver, that interacts with the software of the operating system to enable other programs installed on the computer system to work with a particular attached device without concern for the device's hardware or internal language.

While the hardware utilized in microprocessor-based computer systems is typically modular in nature, computer systems are typically structured with several functional hardware units coupled in parallel to a plurality of buses and housed in a single housing. Typically, the internal bus medium comprises printed circuit traces on a so-called backplane or motherboard. Socket connectors extend from the circuit traces and functional hardware units, built on circuit boards with edge connectors, are plugged into the socket connectors. As a result, many of the hardware units and the motherboard are enclosed in a single case or housing. Additional peripheral devices, located internal or external to the system housing, are connected to the mother board by an I/O (input-output) interface or expansion bus.

If a device is located in the system housing or case, the case must be opened to permit access to the physical and electrical connections for the device when adding or removing the device from the system. If the number of hardware units exceeds the capacity of the housing, an additional housing, including a means of interconnection, such as jumper cables, must be provided. To facilitate aggregating components to create computer systems, modular computer systems have been disclosed having a combination of functional hardware units, such as a video processor or random access memory (RAM), enclosed in separate housings or modules that are physically and electrically connectable to function as a single system. For example, Orr, U.S. Pat. No. 5,909,357, discloses a modular computer system comprising vertically stackable, modular components. One module enclosing a mother board sits on top of and is electrically connected to a second module containing a power supply. The mother board module includes a plurality of ports for connecting external peripheral devices, such as a keyboard, a printer, and a mouse and a bus interconnecting other elements of the system. Other modules enclose additional functional hardware components such as a video card, modular random access memory (RAM) and peripherals, such as a hard drive mass storage device, a removable medium mass storage device, a modem, and a digital camera. The modular construction permits a computer system to be configured by adding or deleting modules as required without the necessity of opening a system case to install or remove hardware.

The modules include a physical interface that permits stacking compatible module housings on one another and an electrical interface in the form of a vertically extending central bus that interconnects all of the modular components. The electrical interconnection could be made through external cables, but, according to the disclosure, the preferred interconnection comprises connectors with alternatively multiple pins or sockets on the top and bottom of each module that mate with complementary pins or sockets of connectors affixed to the tops and bottoms of adjacent modules in the stack. However, the nature of the parallel bus connections necessary to interface the several functional units that typically make up a computer system make the central bus of the modular computer system complex and costly. For example, all compatible modules must be equipped with an interface that will accommodate all other compatible modules even when a system utilizes only a subset of the available compatible modules. Further, each module must be equipped with an identical pair of complementary pin and socket connectors and each of the pins must be electrically connected to the appropriate socket of the complementary connector if the modules are to be stackable in random order. As a result, a 200 pin connector is disclosed for the central bus of the modular computer system. Connectors with large numbers of pins are expensive and require considerable force to engage and disengage making damage probable. Large numbers of wiring connections are expensive to execute and increase the likelihood of a defective connection.

U.S. Pat. No. 5,909,357 suggests that a central bus could take the form of a serial bus meeting the UNIVERSAL SERIAL BUS SPECIFICATION (USB), USB Implementers Forum, 1996; IEEE STANDARD FOR A HIGH PERFORMANCE SERIAL BUS, IEEE 1394 (also known as “Fire Wire”), the Institute of Electrical and Electronic Engineers, 1995; or another standard, but a structure for such a bus is not disclosed. The Universal Serial Bus (USB) specification describes a standardized connector for attaching many common input-output (I/O) devices to a single computer port. Up to 127 devices can be attached to a computer system by daisy chaining the devices using USB hubs that plug into a computer port or another hub and which have a plurality of USB sockets to which the USB devices can be connected. USB was initially intended to be a medium bandwidth interface for common computer peripherals. The bandwidth of earlier USB interconnections was marginal or inadequate for higher data rates peripherals, such as disk drives and audio and video equipment. However, a revised USB 2.0 specification provides an interface with significantly higher data capacity.

The IEEE 1394 interface is also a serial interface and has some similarity to USB. However, IEEE 1394 specifies a high performance interface that is intended for peripheral devices with higher bandwidth requirements, such as camcorders, DVD players, and digital audio equipment. In addition, IEEE 1394 is a peer-to-peer interconnection that permits two devices equipped with the bus to communicate without the necessity of an intervening computer while USB requires communication through a host computer. The ability to transfer data from a device, such as a camera, to another device, such as a mass storage device or printer, without computer intervention is an aspect to IEEE 1394 that is useful for “stand alone” devices such as typical digital audio and video equipment and IEEE 1394 is widely accepted for consumer electronic equipment. On the other hand, it is often desired to communicate between an IEEE 1394 equipped device and a computer for activities such as video editing. Since a computer peripheral is likely to be equipped with one or the other of the USB or IEEE 1394 interfaces, but in most cases not both interfaces, a central bus based on either standard would substantially limit the range of modular components that could be included in a computer system.

What is desired, therefore, is an I/O interface of simple construction, reasonable cost, and enabling simplified construction of a complete computer system including a wide range of modular components and peripherals.

### BRIEF DESCRIPTION OF THE DRAWINGS

FIG. 1 is a block diagram of a typical, prior art microprocessor-based computer system.

FIG. 2 is a block diagram of a computer system including a multiple bus I/O interface.

FIG. 3 is a schematic illustration of an IEEE 1394 peripheral including the multiple bus I/O interface.

FIG. 4 is a schematic illustration of a USB peripheral including the multiple bus I/O interface.

FIG. 5 is a schematic illustration of a peripheral device connectable to the multiple bus I/O interface.

FIG. 6 is a schematic illustration of a peripheral device connectable to the multiple bus I/O interface.

FIG. 7 is an exploded top right perspective of a modular computer system incorporating a multiple bus I/O interface.

### DETAILED DESCRIPTION OF THE INVENTION

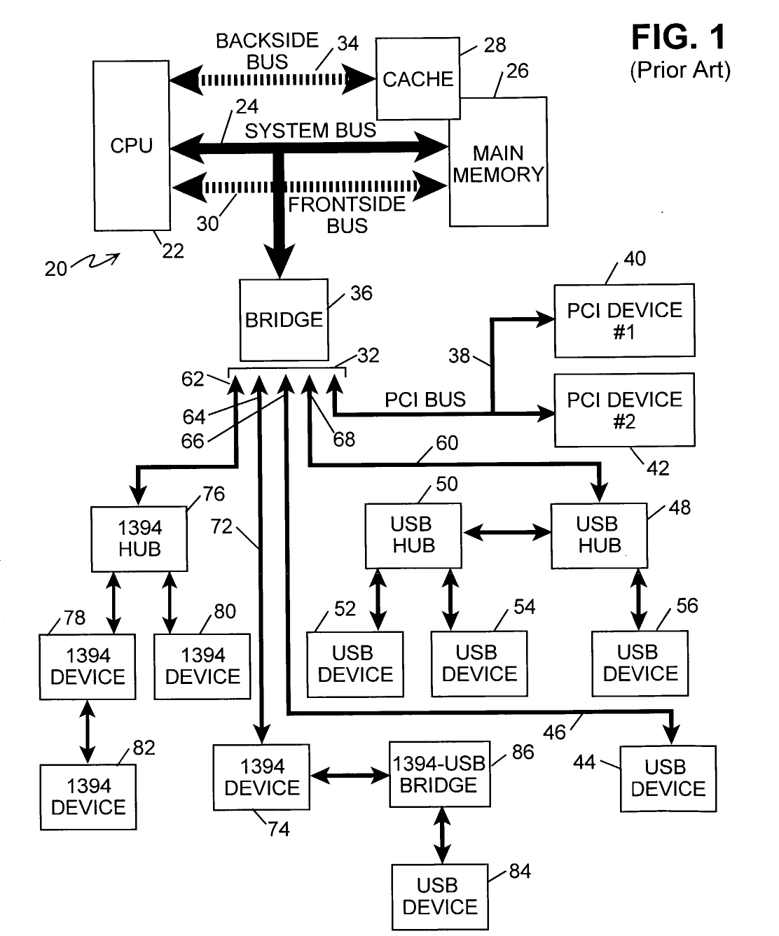

Referring in detail to the drawings wherein similar parts are identified by like reference numerals and, more specifically, FIG. 1, a microprocessor-based computer system 20 is typically a collection of modular components that are transmissively interconnected by a plurality of electrical pathways or buses over which data travels during a processing cycle that transforms the data from an item of input to an item of output. Buses connect all of the system's components, including internal and external hardware, to the system's central processing unit (CPU) 22. Computer buses are often generally classified as system buses and I/O (input-output) buses or interfaces, although no naming convention exists and a number of different names may be used for either type of bus.

The system bus 24 connects the CPU 22 to the main memory 26 and the cache memory 28 , if the system is so equipped. In microprocessors supporting Dual Independent Bus (DIB) architecture a single system bus 24 is replaced by a “frontside bus” 30 used to transfer data between the CPU 22 and main memory 26 and between the CPU and the I/O bus 32 (indicated by a bracket) and a “backside” bus 34 accessing the Level 2 cache memory 28. Dual independent system buses boost the performance of the computer system 20 by enabling the CPU 22 to access data from both the frontside 30 and backside 34 buses simultaneously and in parallel.

The I/O or expansion bus 32 (indicated by a bracket) typically comprises several different buses connecting peripheral devices to the CPU 20. The system bus 24 or frontside bus 30 of the DIB architecture is transmissively connected to the I/O bus 32 through a bridge circuit 36. The I/O bus 32 transmissively connects attached devices or peripherals to the CPU 22. Peripherals are components of the computer system 20 that are not essential to the operation of the CPU 22 but provide the data input, output, and storage that is essential to a useful computer system. Peripherals, such as hard disk mass storage, removable medium mass storage, and modems may be located either inside or outside of the system case that houses the CPU 22. Other input-output peripherals, such as key boards, scanners, and displays are typically located remote from the CPU 22.

A typical component of the I/O bus 32 is the PCI bus 38. The PCI bus specification was issued in 1993 and, within a short period of time, was adopted for a majority of microprocessor-based computer systems. The PCI bus 38 provides improved performance over prior expansion buses used in microprocessor-based computer systems and includes plug and play (PnP) capability that enables the computer system 20 to automatically detect and adjust when PCI devices 40, 42 are added to or removed from the PCI bus. The PCI bus 38 is linked to the system bus 24, 30 through the bridge circuit 36 and operates at a fixed speed, regardless of the processor clock speed. Since its introduction, the PCI bus 38 has served as the main communication path for performance critical components, such as hard disk drives and graphics controllers. The PCI bus 38 is limited to five connectors, although each can be replaced by two devices built into the system motherboard. It is common to mount PCI interconnected devices 40, 42 , such as a disk drive or a graphics controller directly to the motherboard or on expansion cards located in PCI slots adjacent to the motherboard. It is likely that the PCI bus will be replaced in the near future with a bus having a higher bandwidth as input-output bandwidth requirements have steadily increased for microprocessor-based computer systems.

The Universal Serial Bus (USB) was developed to replace the RS232 and Centronics ports that were used to connect many peripherals to earlier personal computers (PC). The USB also incorporates plug and play capability to automatically detect and install peripherals and typically eliminates the need to open the housing of a PC when connecting a new peripheral. The bus is used to connect specialized input-output devices such as scientific instruments, machine controls, and on-board telemetry for racing cars, as well as common PC peripherals, such as printers and modems. Originally released in January 1996, USB 1.0 provided a data rate up to 12 Mbits/sec. While this bandwidth substantially exceeds the bandwidth of the ports that USB was intended to replace the bandwidth was marginal or inadequate for peripherals with higher data rates. In early 2000 a revised USB specification (2.0) was released providing an I/O bus with a bandwidth up to 480 Mbits/sec.

USB utilizes a four-wire cable interface. The data channel is established by two of the wires that are used in a differential mode. The third and fourth wires are power (+5 v.) and ground. While devices can be powered by the bus, the power available from the bus is not adequate for many devices. The cable is connected to a port of a computer which acts as the host for the USB providing bus management. The USB divides the bandwidth into frames containing 1500 bytes with a new frame initiated every millisecond. The host controls the frames so that isochronous data transfers are guaranteed their required bandwidth and bulk and control data transfers utilize the remaining capacity of the frame.

USB devices 44 can be connected directly to the computer's port 66 through a USB interconnection 46. While USB devices can not be daisy chained from device to device, up to 127 devices can be connected to a single USB port by the utilizing a tree topology having hub connections. A hub 48, 50 provides a common connection point for a plurality of devices. Up to seven USB peripherals 56, including a hub 50, can be connected to a USB hub 48. Up to seven peripherals 52, 54 can be connected to the second hub 50 and so forth, effectively daisy chaining the peripherals attached to the port 68 of the I/O interface 32 by USB interface 60.

While USB can be and is used to connect a wide range of computer peripherals and a recent revision of the specification has substantially increased the bandwidth of the bus, the IEEE 1394 specification (IEEE 1394-1995, HIGH PERFORMANCE SERIAL BUS) (also known as “Firewire”) provides the protocol for an interface that is commonly used with consumer electronic equipment, such as digital audio and video equipment. IEEE 1394 is a high capacity serial bus with a maximum data rate of 400 Mbits/sec. A proposed IEEE 1394b standard anticipates extending the 1394 bus to enable data rates to 3.2 Gbits/sec. and cable runs to 500 meters on mulitmode, glass, optical fiber. Like USB, IEEE 1394 provides plug and play automatic network configuration. In addition, the IEEE 1394 bus provides for isochronous data transfer facilitating data delivery at a guaranteed rate which is very desirable for devices, such as video devices, that transfer data in real time. Up to 63 external devices can be connected to an IEEE 1394 port with a cable that includes two separately shielded twisted pair data transmission channels, two power conductors, and a shield. The IEEE 1394 bus includes multi-master capabilities permitting peer-to-peer interfacing of IEEE 1394 devices and rendering a bus management connection to a PC unnecessary. The peer-to-peer interface provided by the IEEE 1394 bus is particularly useful for consumer electronics devices which are often stand alone devices. For example, one camcorder can be connected to a second camcorder for dubbing without the intervention of a computer.

The I/O bus 32 typical of personal computer provides a limited number of ports 62, 64, 66, 68, 70 for connecting peripheral devices. Devices utilizing a IEEE 1394 interconnection 72 (a 1394 device 74) or a USB interconnection 46 (a USB device 44) can be connected directly to one of the available ports 64, 66. On the other hand, an IEEE 1394 hub 76 or a USB hub 48 can be connected to an appropriate port 62, 62 and devices 78, 80, 50 connected to the appropriate hub. IEEE 1394 supports daisy chaining of devices permitting a device 82 to be connected in series with another device 78. USB supports daisy chaining by connecting a device 54 to a hub 50 that is, in turn, connected to another hub 48. Typically, devices are not equipped with both interfaces and a device with one interface can not be connected directly to the second interface, however, a device (for example, USB device 84) can be connected to a translating bridge circuit 86 that can be connected to the other type of interface. However, translation bridges can be relatively expensive and the performance of the device 84 may be compromised by the performance of the bus that connects the device to the bridge 36.

The inventor concluded that the point-to-point bus connections required for a modular computer system substantially increased the complexity and cost of the system. Further, a high performance serial I/O interface could substantially reduce the number of bus connections required to construct a modular computer system, but could limit the flexibility and adaptability of systems constructed with the interface. The inventor concluded that a multiple format, high speed serial interface could provide substantially universal connectivity for computer components and facilitate the construction of computer systems with modular components.

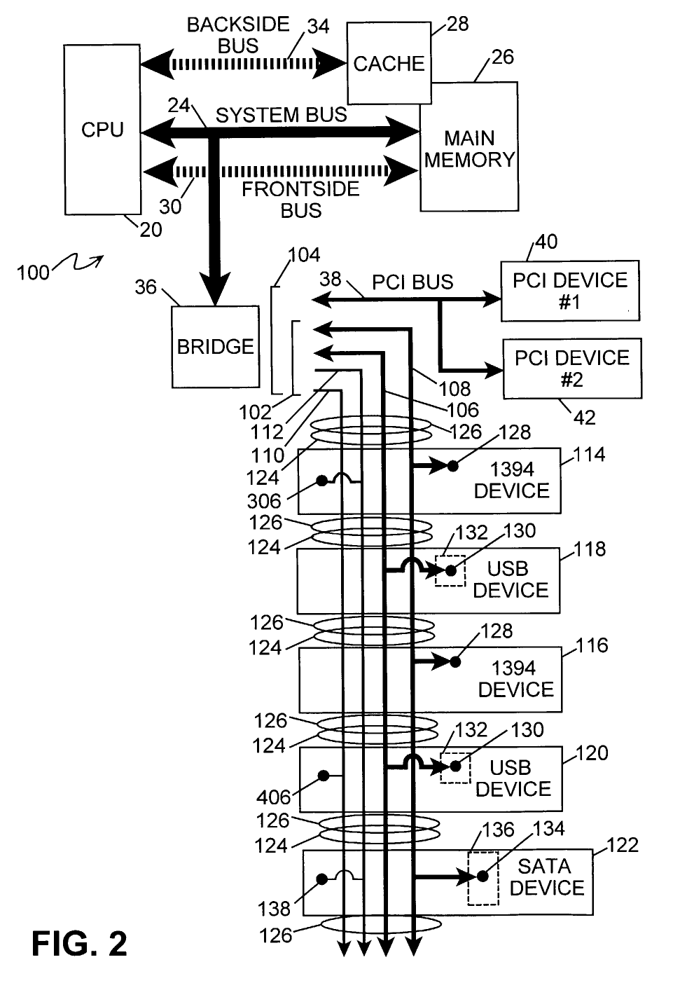

Referring FIG. 2, a computer system 100 including the multiple bus, I/O interface 102 comprises a CPU 20, main memory 26, cache memory 28, and a system bus 24. The system bus 24 may comprise a backside bus 34 connecting the CPU 22 to the cache 28 and a front side bus 30 connecting the CPU 22 and the main memory 26 as prescribed by the dual independent bus architecture. The front side bus 30 or system bus 24 provides the communication path from the CPU 22 to a bridge 36 which is, in turn, transmissively connected to the I/O or expansion bus 104 (indicated by a bracket). The I/O bus 104 comprises generally a PCI bus 38 interfacing one or more PCI devices 40, 42 and the multi-bus, I/O interface 102 (indicated by a bracket). Additional data transfer buses, such as an ISA bus or an IDE bus (not illustrated) may be included in the expansion bus 104.

The I/O interface 102 comprises, generally, a plurality of data transmission pathways or channels 106, 108 and power transmission lines 110, 112 transmissively connecting the bridge 36 of the host computer to a plurality of attached peripheral devices. While the data transmission channels are typically electrical conductors, the transmission channels could comprise optical fiber or a mixture of optical fiber and electrical conductors. A peripheral device may be connected to the bridge 36 by a data connection conforming to the specifications of one of the data channels 106, 108 or may be connected to the I/O interface by a translation bridge. In a preferred embodiment, one data transmission channel 108 of the I/O interface 102 conforms to the protocols of the IEEE 1394 specification and the second channel 106 conforms to the protocols of the USB specification. The I/O interface 102 is connected to each attached peripheral device 114, 116, 118, 120, 122 by a pair of mating multi-conductor connectors 124, 126. Each data channel 106, 108 passes through the attached device from an first connector 126 to a second connector 124. The peripheral device includes a data connection 128, 130 to one of the channels 106, 108 appropriate to provide signals useful to the device while the remaining channel transparently connects the first 126 and second 124 connectors.

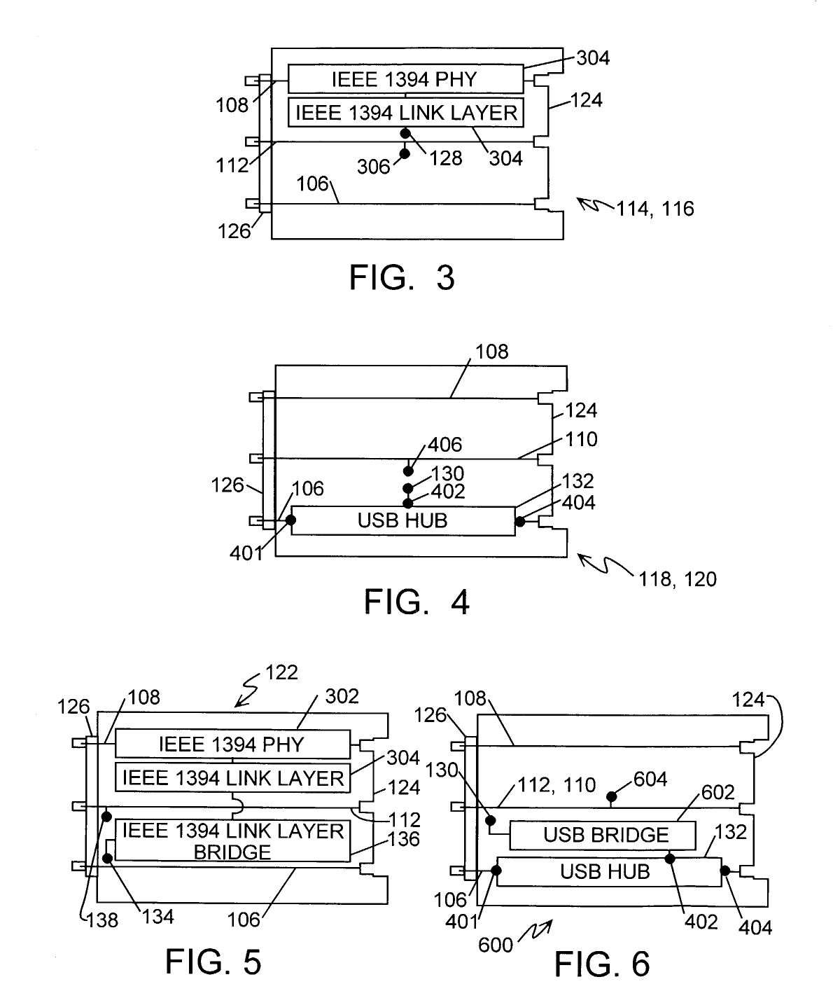

Referring to FIG. 3, a 1394 device 114, 116 has a data connection 128 to the IEEE 1394 data channel 108 of the I/O interface 102 while signals on the USB data channel 106 are transparently passed from the first connector 126 to the second connector 124 of the device. The data connection 128 of the 1394 device 114, 116 is made through the physical layer 302 and the link layer 304 of the IEEE 1394 interface. The link layer chip 304 transmits and receives 1394 data packets and supports asynchronous and isochronous data transfers while the physical layer 302 initializes and arbitrates bus transactions and translates the bus data signals to those required by the link layer. In addition, the device may be powered through a connection 306 to one of the power transmission channels 112 of the I/O interface 102.

Referring to FIG. 4, a USB device 118, 120 includes a data connection 130 to the USB channel 106 of the I/O interface 102 while the IEEE 1394 pathway 108 transparently passes IEEE 1394 signals from the first connector 126 to the second connector 124 of the device. To permit daisy-chaining of USB peripherals 118, 120, the data connection 130 of the USB peripheral is accomplished through a USB hub 132 having at least three ports 401, 402, 404. One of the ports 402 provides the data connection 130 to the device 118 while a second port 404 provides the transmissive connection through the data channel 106 for the next device 120. The port 401 connects to the connector 126 to transmissively connect the device and the prior device on the USB channel. The USB device 118, 120 may also be powered by a connection 406 to a power transmission line 110 of the interface 102.

A peripheral requiring signals that do not conform to one of the protocols of the data channels 106, 108 of the I/O interface 102 can be connected to the I/O interface by a translation bridge. For example, a disk drive or other device 122 having a serial ATA (SATA) interface can be connected 134 to the IEEE 1394 data channel 108 through a translation bridge 136. Referring to FIG. 5, the translation bridge 136 translates the SATA signals output to the data connection 134 to signals suitable for input to the IEEE 1394 link layer 304 which is connected to the IEEE 1394 channel 108 through the physical layer 302. The device may also be powered through a connection 138 to one of the power transmission lines 112, 110 of the I/O interface 102. USB signaling is passed from the first connector 126 to the second connector 124 by the USB data channel 106.

Referring to FIG. 6, similarly, a device 600 utilizing signals not conforming to the USB protocols may be connected to the USB data channel 106 by a translation bridge 602 connected 402 to the hub 132 of the device. Signals for the IEEE 1394 channel 108 are passed through the device 600 from the first connector 126 to the second connector 124 and the device may be powered by a connection 604 to a power supply line 110, 112 of the I/O interface 102. Devices having other signaling protocols may be connected to the I/O interface in a similar manner. Since the I/O interface provides a choice of high speed serial data channels, a wide range of peripherals can be aggregated into a system without the use of large numbers of translation bridges.

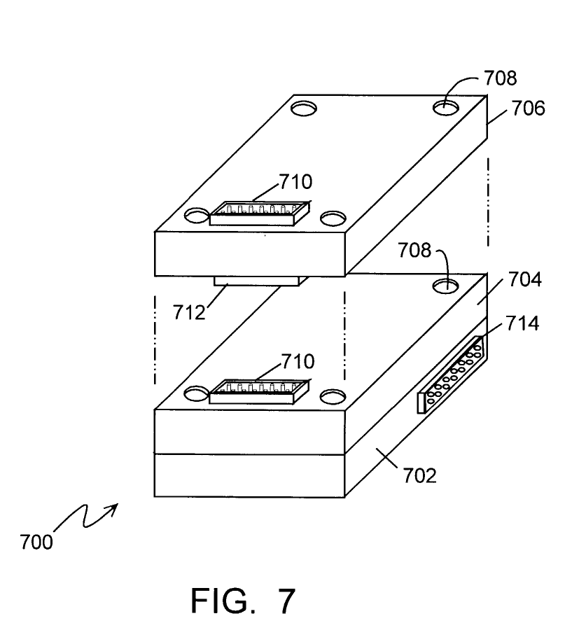

Referring to FIG. 7, the multiple bus interface facilitates the construction of a computer system 700 comprising an aggregate of modular components 702, 704, 706. A compact arrangement of the system can be accomplished by stacking modules on top of each other. A pattern of surface indentations 708 that match protrusions (not shown) on the mating surface of the adjacent module are useful in positioning the stacked modules 702, 704, 706.

The computer system 700 typically includes a module 702 including a CPU. The CPU module may also include a power supply and memory, but the power supply and some portion of the memory might be contained in separate module. Personal computer systems typically include a hard disk drive mass storage unit 704, such as the serial ATA device 122, which is connectable to the CPU by the multiple bus interface 102. Other modular peripheral devices, such as device 706, include, without limitation, removal media mass storage, such as floopy disk drives, CD, and DVD drives; modems; video and audio equipment and processors; keyboards; and a mouse which are interconnected by the multiple bus interface 102.

To interconnect the modular components 702, 704, 706, the modules include complementary connectors 124, 126 for the multiple bus interface 102. Polarized, complementary connectors 710, 712 mounted on the upper and lower surfaces, respectively, of the modules facilitate interconnection of the stacked modules. However, the complementary connectors could be mounted on another surface of each module and interconnected with a cable including the conductors of the multiple bus interface 102. To connect remotely mounted peripherals, one connector 714 of the complementary pair of multiple bus interface connectors 126, 124 is mounted on a surface on a module 702 to receive a cable from the remote peripherals.

The multiple bus interface 102 provides a convenient interface for peripherals while requiring a limited number of connections. A polarized connector with fifteen pins can accommodate the interface comprising USB and IEEE 1394 data channels and a power bus with, for example, the following pin assignments:

| Pin Number | Pin Assignment |
|---|---|
| 0 | Power Bus +12 v. |
| 1 | Power Bus 12 v. Ground |
| 2 | Power Bus +5 v. |
| 3 | Power Bus 5 v. Ground |
| 4 | USB +5 V |
| 5 | USB Data D0+ |
| 6 | USB Data D0− |
| 7 | USB Ground |
| 8 | USB Ground |
| 9 | IEEE 1394 Power |
| 10 | IEEE 1394 Ground |
| 11 | IEEE 1394 TP(twisted pair)B− |
| 12 | IEEE 1394 TPB+ |
| 13 | IEEE 1394 TPA− |
| 14 | IEEE 1394 TPB+ |

A multiple bus, serial interface provides a convenient interface for the peripheral devices of a computer system making construction of a system with modular components practical and economical.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

The invention claimed is:

1. An interface for connecting a first device of a computer system to a second device of said computer system, said interface comprising:
(a) a first connector arranged for transmissive engagement with said second device;
(b) a second connector arranged for transmissive engagement with a third device;
(c) a first data channel connected to communicate data serially from said first connector to said second connector;
(d) a second data channel connected to communicate data serially from said first connector to said second connector; and
(e) a data connection from one of said first data channel and said second data channel to said first device.

2. The interface of claim 1 wherein one of said first data channel and said second data channel conforms to a Universal Serial Bus specification.

3. The interface of claim 2 wherein said data connection comprises a hub having a first port connected to said first connector, a second port connected to said first device and a third port connected to said second connector.

4. The interface of claim 2 wherein said data connection comprises:
(a) a translation bridge converting a signal useful to said first device to a signal compatible with said Universal Serial Bus specification; and
(b) a hub having a first port connected to said first connector, a second port connected to said translation bridge, and a third port connected to said second connector.

5. The interface of claim 1 wherein one of said first data channel and said second data channel conforms to an IEEE 1394 serial bus specification.

6. The interface of claim 5 further comprising a translation bridge converting a signal compatible with said IEEE 1394 specification to a signal useful to said first device.

7. The interface of claim 1 further comprising:
(a) a power conductor conductively connecting said first connector and said second connector; and
(b) a power connection connecting said power conductor to said first device.

8. A computer system comprising:
(a) a processing unit;
(b) a peripheral device; and
(c) an interface transmissively connecting said processing unit and said peripheral device, said interface comprising a first communication channel for transmission of a first signal according to a first serial protocol, a second communication channel for transmission of a second signal according to a second serial protocol, and a data connection from one of said first and said second communication channels to said peripheral device.

9. The computer system of claim 8 wherein one of said first communication channel and said second communication channel transmits signals conforming to a Universal Serial Bus specification.

10. The computer system of claim 9 wherein said data connection comprises a hub having a first port transmissively connected to said processing unit, a second port connected to said peripheral device and a third port transmissively connectable to another peripheral device.

11. The interface of claim 9 wherein said data connection comprises:
(a) a translation bridge converting a signal useful to said peripheral device to a signal conforming to said Universal Serial Bus specification; and
(b) a hub having a first port transmissively connected to said processing unit, a second port transmissively connected to said translation bridge, and a third port transmissively connectable to another peripheral device.

12. The computer of claim 8 wherein one of said first communication channel and said second communication channel conforms to an IEEE 1394 serial bus specification.

13. The interface of claim 12 further comprising a translation bridge converting a signal conforming to said IEEE 1394 specification to a signal useful to said peripheral device.

14. The computer system of claim 8 wherein said interface further comprises
(a) a power conductor; and
(b) a power connection connecting said power conductor and said peripheral device.
